(19) United States
(12) Patent Application Publication
(10) Pub. No.: US 2006/0218223 A1
(43) Pub. Date: Sep. 28, 2006

(54) Asynchronous communication method

(75) Inventors: Atsushi Uchida, Kawasaki (JP); Shigeyuki Sano, Kawasaki (JP); Eiichi Mitsuhashi, Tokyo (JP); Tsuyoshi Kunigou, Tokyo (JP); Shigeki Oogami, Tokyo (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/191,717

(22) Filed: Jul. 28, 2005

(30) Foreign Application Priority Data
Mar. 24, 2005 (JP) JP2005-086067

(51) Int. Cl. G06F 15/16

(52) U.S. Cl. 709/201

(57) ABSTRACT

To provide a technology of distributing a content in real-time at a high efficiency by asynchronously distributing only an updated portion when updating the content. A communication method performed by a management device and a client terminal that are connected via a network, wherein the management device executes steps of establishing a connection with the client terminal that transmits at least part of a content via the network, detecting an update of the content, and transmitting the updated portion to the client terminal as triggered by the detected update of the content, and the client terminal executes steps of establishing a connection with the management device, waiting for the updated portion of the content, and updating partially the content on the basis of the updated portion received during the waiting step.

### BACKGROUND OF THE INVENTION

The invention relates to a technology of performing push type distribution of information via a network such as the Internet.

In the network such as the Internet and Intranet, so-called pull type distribution of information is generally conducted, wherein a request for acquiring information (Web content) specified by a URL (Uniform Resource Locator) is given from the side of a client terminal, and a server distributes the specified Web content in response to this request to the client.

In this type of network system, if abnormality occurs in a device in, e.g., a plant, there is no means for establishing communications with the terminal in response to an event occurred on the server side even by trying to perform the push type distribution of the information such as distributing the information from the server installed in the plant, which leads to no actualization of the push type distribution of the information.

Such being the case, it is general to actualize the push type distribution in a pseudo manner through so-called polling type distribution of information, wherein JavaScript (Java and JavaScript are registered trademarks) is embedded in a HTML-based description configuring a Web content, and new pieces of information are periodically collected by invoking an HTML page generation program on the server from the client terminal.

Further, the prior art related to the invention of the application is a technology disclosed in, for instance, Patent document 1 or 2.

[Patent document 1] Japanese Patent Application Laid-Open Publication No.10-171526

[Patent document 2] Japanese Patent Application Laid-Open Publication No.2001-350507

### SUMMARY OF THE INVENTION

If by the polling type distribution of the information, a query is given to the server side from the terminal side with a fixed period, and hence the communications are performed even in such a case that there is no update information, resulting in such a problem that futile traffic occurs.

Another problem is that the client terminal acquires the information with only this fixed period, and therefore, even when the information is updated on the server side, this update does not reflect in the client terminal till the client terminal makes a next query, resulting in occurrence of a time lag in the distribution of the information.

Namely, in the case of conducting the polling type distribution of the information, if a query interval is set long, there increases the time lag till the updated information reflects in the terminal, and a status of the plant (server) can not be correctly displayed. Whereas if the query interval is set short, a network utilizing efficiency is worsened by making the query even when there is no update information.

Moreover, in the case of the polling type communication method, the information to be acquired when making the query is obtained page by page based on HTML, it therefore follows that the whole page is acquired even when the updated content is part of the page. Consequently, a size of the information to be acquired is larger than a size of the information to be updated, so that futility occurs in the traffic between the server and the terminal.

Under such circumstances, the invention provides a technology of distributing the content in real time at a high efficiency by asynchronously distributing, when the content has been updated, only the updated portion.

The invention adopts the following configurations in order to solve the problems.

Namely, an asynchronous communication system of the invention is configured by a management device and a client terminal that are connected via a network,

the management device comprising:

a connection module establishing a connection with the client terminal that transmits at least part of a content via the network;

a detection module detecting an update of the content; and

a partial distribution module transmitting the updated portion to the client terminal as triggered by the update of the content that has been detected by the detection module,

the client terminal comprising:

a connection module establishing a connection with the management device;

a waiting module waiting for the updated portion of the content; and

a partial updating module updating partially the content on the basis of the updated portion received by the waiting portion.

Further, an asynchronous communication method of the invention is performed by a management device and a client terminal that are connected via a network,

the management device executing:

a step of establishing a connection with the client terminal that transmits at least part of a content via the network;

a step of detecting an update of the content; and

a step of transmitting the updated portion to the client terminal as triggered by the detected update of the content,

the client terminal executing:

a step of establishing a connection with the management device;

a step of waiting for the updated portion of the content; and

a step of updating partially the content on the basis of the updated portion received during the waiting step.

In the asynchronous communication system and in the asynchronous communication method, the content may be monitor information of a device, and

the management device may acquire the monitor information of the device and, if the monitor information changes, detect this change as an update of the content, and transmit information of the updated portion from the monitor information as an updated portion.

In the asynchronous communication system and in the asynchronous communication method, the management device may further execute a step of transmitting, as the content, an HTML- or XML-described Web page to the client terminal, and

the client terminal may further execute a step of receiving the Web page as the content, and update a portion defined by the description in the Web page on the basis of the updated portion.

Further, a management device of the invention is connected to a client terminal via a network, the management device comprising:

a connection module establishing a connection with the client terminal that transmits at least part of a content via the network;

a detection module detecting an update of the content; and

a partial distribution module transmitting the updated portion to the client terminal as triggered by the update of the content that has been detected by the detection module.

Moreover, an asynchronous communication method of the invention is performed by a management device connected to a client terminal via a network,

the management device executing:

a step of establishing a connection with the client terminal that transmits at least part of a content via the network;

a step of detecting an update of the content; and

a step of transmitting the updated portion to the client terminal as triggered by the detected update of the content.

In the management device and the asynchronous communication method, the content may be monitor information of a device, and

the monitor information of the device may be acquired, if the monitor information changes, this change may be detected as an update of the content, and information of the updated portion from the monitor information maybe transmitted as an updated portion.

The management device may transmit the updated portion in an XML format or a CSV (Comma Separated Value) format.

Further, a client terminal of the invention is connected to a management device via a network, the terminal comprising:

a connection module establishing a connection with the management device in order to receive at least part of a content via the network;

a waiting module waiting for the updated portion of the content; and

a partial updating module updating partially the content on the basis of the updated portion received by the waiting portion.

Moreover, an asynchronous communication method of the invention is performed by a client terminal connected to a management device via a network, the client terminal executing:

a step of establishing a connection with the management device in order to receive at least part of a content via the network;

a step of waiting for the updated portion of the content; and

a step of updating partially the content on the basis of the updated portion received by the waiting portion.

Further, the invention may be an asynchronous communication program for making a computer execute the asynchronous communication method. Moreover, the invention may also be a readable-by-computer recording medium recorded with this asynchronous communication program. The computer is made to read and execute the program on this recording medium, thereby enabling functions thereof to be provided.

Herein, the recording medium readable by the computer connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the recording mediums fixed within the computer.

According to the invention, it is possible to provide a technology of distributing the content in real time at a high efficiency by asynchronously distributing, when the content has been updated, only the updated portion.

### BRIEF DESCRIPTION OF THE DRAWINGS

FIG. 1 is a schematic view of a communication system according to the invention.

FIG. 2 is a schematic diagram of a configuration of a monitoring server.

FIG. 3 is a schematic diagram of a configuration of a client terminal.

FIG. 4 is an explanatory diagram of an asynchronous communication method.

FIG. 5 is an explanatory diagram of a software architecture for actualizing the asynchronous communication method.

FIG. 6 is an explanatory diagram when loading a management screen into the client terminal.

FIG. 7 is an explanatory diagram when transmitting partial information.

FIG. 8 is an explanatory diagram when effecting partial updating.

FIG. 9 is an explanatory diagram when effecting the partial updating.

FIG. 10 is an explanatory diagram of a specific example of the asynchronous communication method.

FIG. 11 is a diagram showing an example of the management screen.

FIG. 12 is a diagram showing an example of the management screen.

FIG. 13 is a diagram showing an example of the management screen.

FIG. 14 is a diagram showing an example of the management screen.

FIG. 15 is a diagram showing an example of the partial information.

FIG. 16 is a diagram showing an example of the partial information.

FIG. 17 is a diagram showing an example of the partial information.

FIG. 18 is a diagram showing an example of the partial information.

FIG. 19 is a diagram showing an example of the partial information.

FIG. 20 is a diagram showing an example of the partial information.

FIG. 21 is a diagram showing an example of the partial information.

FIG. 22 is a diagram showing an example of the partial information.

FIG. 23 is a diagram showing an example of the partial information.

FIG. 24 is a diagram showing an example of the partial information.

FIG. 25 is a diagram showing an example of the partial information.

FIG. 26 is a diagram showing an example of the partial information.

FIG. 27 is a diagram showing an example of the partial information.

### DETAILED DESCRIPTION OF THE PREFERRED EMBODIMENT

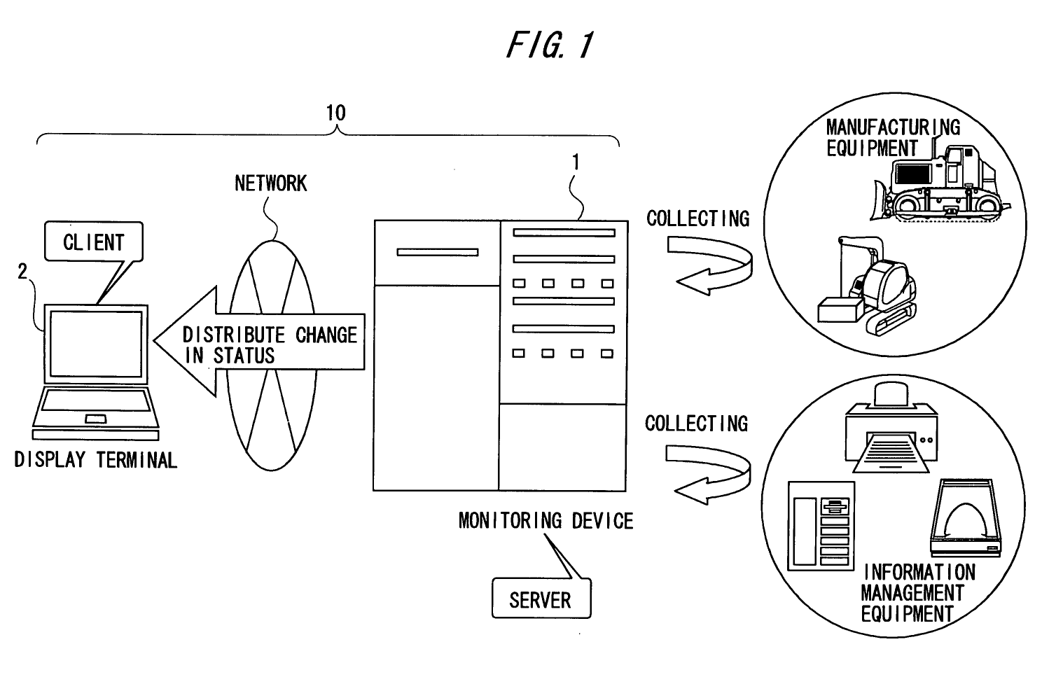

FIG. 1 is a schematic view of a communication system according to the invention.

A communication system 10 in this example is configured by a Web server (management device) 1 and a client terminal 2, which are connected via a network such as Internet etc., wherein the server 1 monitors a status of production equipment of a factory, a status of information management equipment, etc., and provides the statuses of the equipment (devices) as Web contents to the client terminal 2 any time, thereby enabling an administrator residing in a remote place to grasp the status of the factory in real-time by use of Web browser of the client terminal 2.

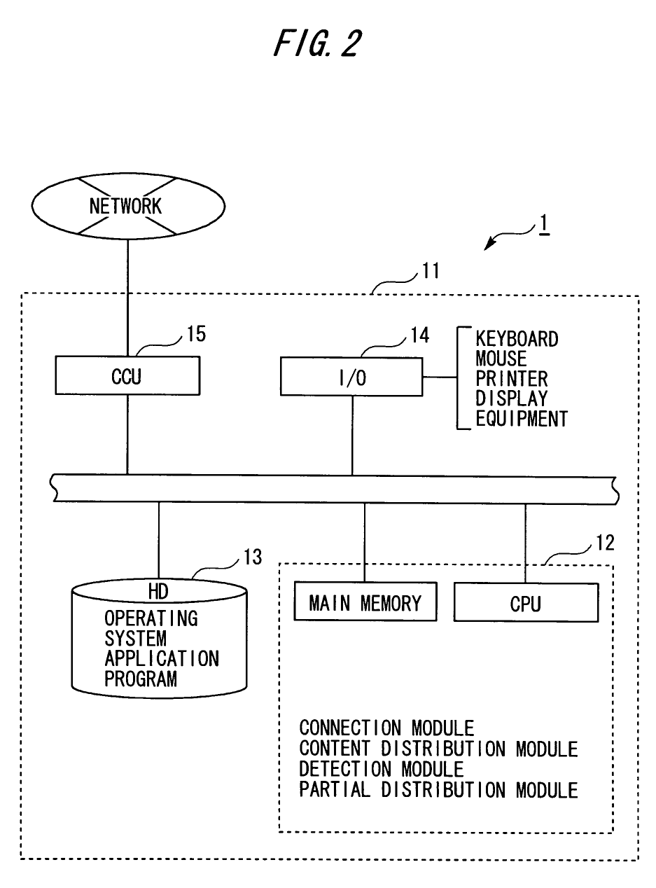

FIG. 2 is a schematic diagram of a configuration of the Web server 1 in this embodiment. As shown in FIG. 2, the monitor server 1 is a general type of computer having a main body 11 that contains inside an arithmetic processing unit 12 constructed of a CPU (Central Processing Unit), a main memory, etc., a storage unit (had disc) 13 stored with data and software for arithmetic processing, an input/output port 14, a communication control unit (CCU) 15 and so on.

Input devices such as a keyboard and a mouse and output devices such as a display device and a printer are properly connected to the I/O port 14. Further, the production equipment and the information management equipment are connected to the I/O port 14 to which information (status information) showing the status is inputted from the equipment, and from which control information is outputted to the equipment.

The communication control unit 15 executes control for communicating with other computer via the network.

The storage unit 13 is preinstalled with operating system (OS) and application software (program).

The arithmetic processing unit 12 properly reads the OS and the application program from the storage unit 13, then executes the OS and the application program, and effects the arithmetic processing of information inputted from the I/O port 14 and from the communication control unit 15 and information read from the storage unit 13, thereby functioning also as a connection module, a content distribution module, a detection module and a partial information distribution module.

The connection module establishes a connection (asynchronous path) with the client terminal 2 transmitting the Web content. Note that the connection with the client terminal 2 is kept while performing asynchronous communications, but is not cut off each time the Web content is transmitted.

The content distribution module transmits a management screen, as the Web content, for the production equipment and the information management equipment to the client terminal 2 defined as a requester. The management screen is an HTML- or XML-based Web page and can be browsed on the Web browser of the client terminal 2.

The detection module receives the transmitted information with a predetermined period from each equipment via the I/O port 14, and detects a change in this information as updating of the Web content.

The partial information distribution module transmits, as triggered by the updating of the Web content that has been detected by the detection module, the updated part, i.e., information of the updated part on the management screen (which will hereinafter be referred to also as partial information) to the client terminal 2. Accordingly, the partial information distribution module in the embodiment does not transmit the partial information in response to a request but transmits asynchronously the partial information to the client terminal 2.

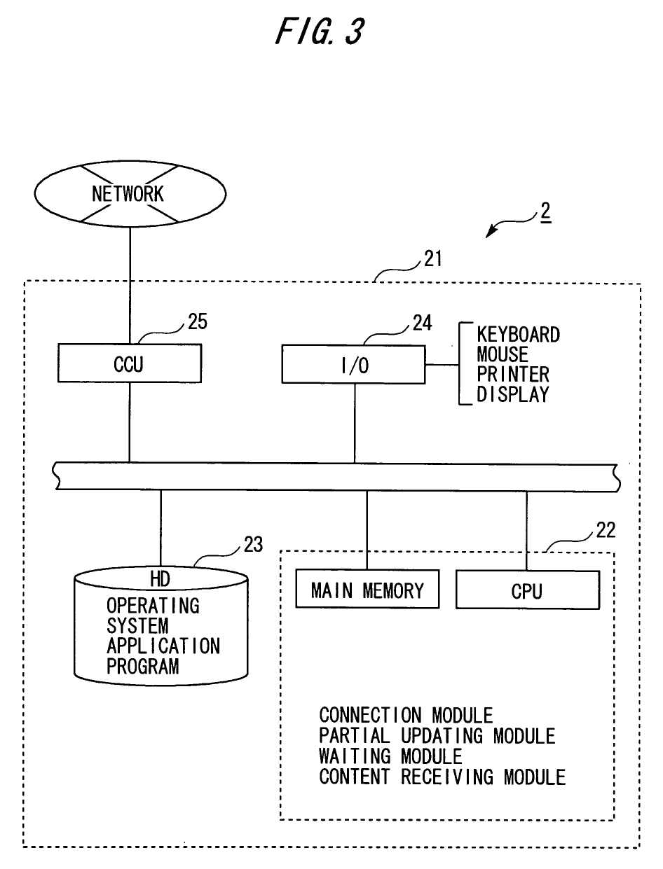

FIG. 3 is a schematic diagram of a configuration of the client terminal 2 in the embodiment. As shown in FIG. 3, the client terminal 2 is a general purpose type of computer having a main body 21 that contains inside an arithmetic processing unit 22 constructed of a CPU (Central Processing Unit), a main memory, etc., a storage unit (hard disc) 23 stored with data and software for arithmetic processing, an input/output port 24, a communication control unit (CCU) 25 and so on.

Input devices such as a keyboard and a mouse and output devices such as a display device and a printer are properly connected to the I/O port 24.

The communication control unit 15 executes control for communicating with other computer via the network.

The storage unit 23 is preinstalled with operating system (OS) and application programs (an asynchronous communication program, JavaVM, etc.).

The arithmetic processing unit 22 properly reads the OS and the application programs from the storage unit 23, then executes the OS and the application programs, and effects the arithmetic processing of information (JavaScript etc. in the Web page) inputted from the I/O port 24 and from the communication control unit 25 and information read from the storage unit 23, thereby functioning also as a connection module, a partial updating module, a waiting module and a content receiving module.

The connection module establishes the connection (asynchronous path) with the server 1.

The content receiving module receives as the Web content.

The waiting module, during the asynchronous communications, waits for the partial information from the Web server 1, and, when receiving the partial information, notifies the partial updating module of this reception.

The partial updating module partially updates the Web content on the basis of the updated part received by the waiting module.

Further, the Web browser of the client terminal 2 may have, without being limited to receiving the partial updated information, a function (transmitting module) of transmitting instructions such as arbitration of the equipment and a switchover to a standby system, corresponding to the received equipment status. The information such as the instructions may be transmitted by use of the asynchronous path and also by separately employing a standard path (which is a general path via which the server sends back in response to a request of the client). If in the case of sharing the asynchronous path, the communications are performed in a way that attaches tags etc. for distinguishing between the partial formation and information other than the partial information, and the control may be done so as not to disconnect the path on a communication-by-communication basis also in the case of conducting the communications of the information other than the partial information. Note that a procedure of transmitting the information such as the instructions from other client terminals 2 is the same as the communication procedure between the general Web browser and the server, and is therefore omitted.

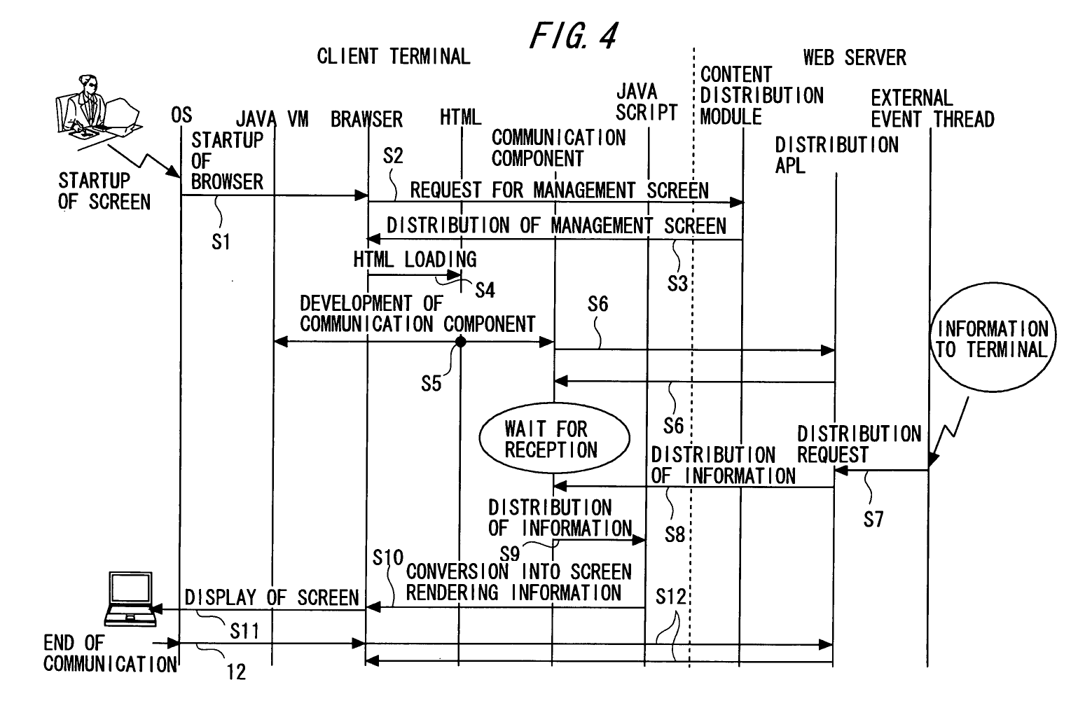

Next, an asynchronous communication method executed in the communication system 10 will be described. FIG. 4 is an explanatory diagram of a sequence of this asynchronous communication method, and FIG. 5 is an explanatory diagram of a software architecture for actualizing the asynchronous communication method.

When the administrator manipulates to open the management screen by designating a URL, the client terminal 2 starts up the Web browser (step 1, which will hereinafter be abbreviated such as S1), then connects to the Web server 1 on the basis of the URL, and makes a request (S2).

In response to this, the content distribution module of the Web server 1 transmits the management screen to the client terminal 2 (S3).

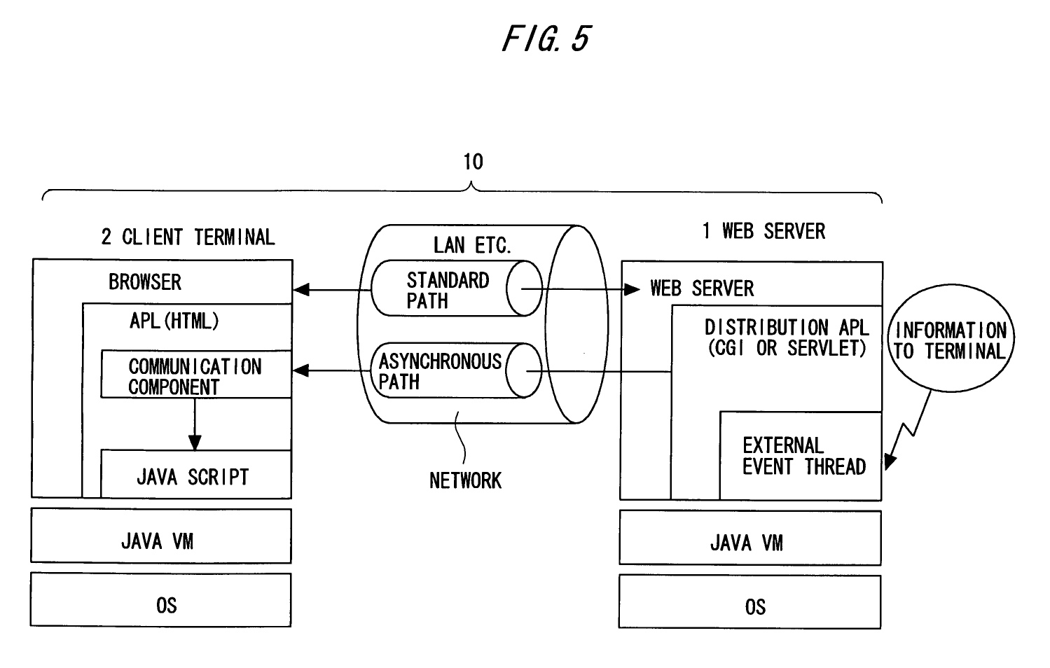

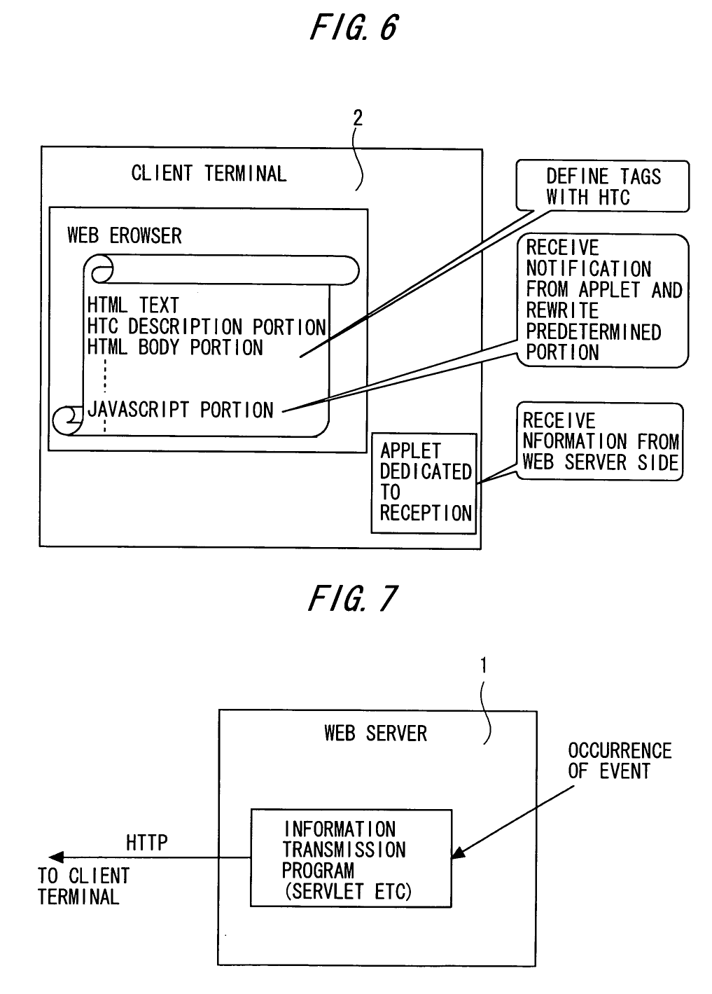

The client terminal 2 loads the management screen received via the communication control unit 25 into the arithmetic processing unit 22 (S4), then gets the management screen displayed on the display device in accordance with the HTML description configuring the management screen, and develops a communication component for acquiring the partial information (S5). FIG. 6 is an explanatory diagram when the client terminal 2 loads the management screen. The HTML text on the management screen contains an HTC (HTML Component) description part that defines tags for partial updating, and a JavaScript part for actualizing a function of the partial updating module for executing the partial updating based on the tag definition. Further, the client terminal 2 has a receiving program (JAVA Applet) serving as the waiting module for notifying the partial updating module of the reception of the partial information. Note that in the example, the management screen is transmitted to the client terminal 2 from the content distribution module of the Web server 1 and may also be, without being limited to this transmission, stored on the storage unit 23 of the client terminal 2 and loaded from this storage unit 23. Similarly, the receiving program may be transmitted to the client terminal 2 from the Web server 1 and may also be read from the storage unit 23.

On the occasion of loading this management screen, when the browser of the client terminal 2 requests the Web server 1 for the updated part (Web content) on the management screen, the connection module of the client terminal 2 and the connection module of the Web server 1 establish a connection (CONNECTION) based on TCP (Transmission Control Protocol) (S6). In the example, this connection is not made open but is set as the asynchronous path (FIG. 5) for transmitting the partial information to the client terminal 2 from the Web server 1 as the necessity arises (asynchronously).

When setting this asynchronous path, the Web server 1 starts the detection by the detection module thereof, then, if the information given from the equipment changes, transfers the changed information (partial information) to a distribution APL (partial distribution module), and requests the distribution APL for distribution (S7).

The distribution APL, when receiving this partial information, i.e., when triggered by updating the Web content, transmits the partial information as a plain text (TEXT) to the client terminal 2 on the basis of HTTP (HyperText Transfer Protocol) as shown in FIG. 7 (S8).

On the other hand, the client terminal 2, when developing the communication component and starting up the receiving program serving as the waiting module, starts waiting for the partial information, and generates a HTC event as triggered by receiving the partial information (S9). Corresponding to this event, the browser of the client terminal 2 executes JavaScript (S10) and updates only an update target part of an HTML page displayed on the browser screen (S11). On this occasion, the whole of the HTML page is not redisplayed.

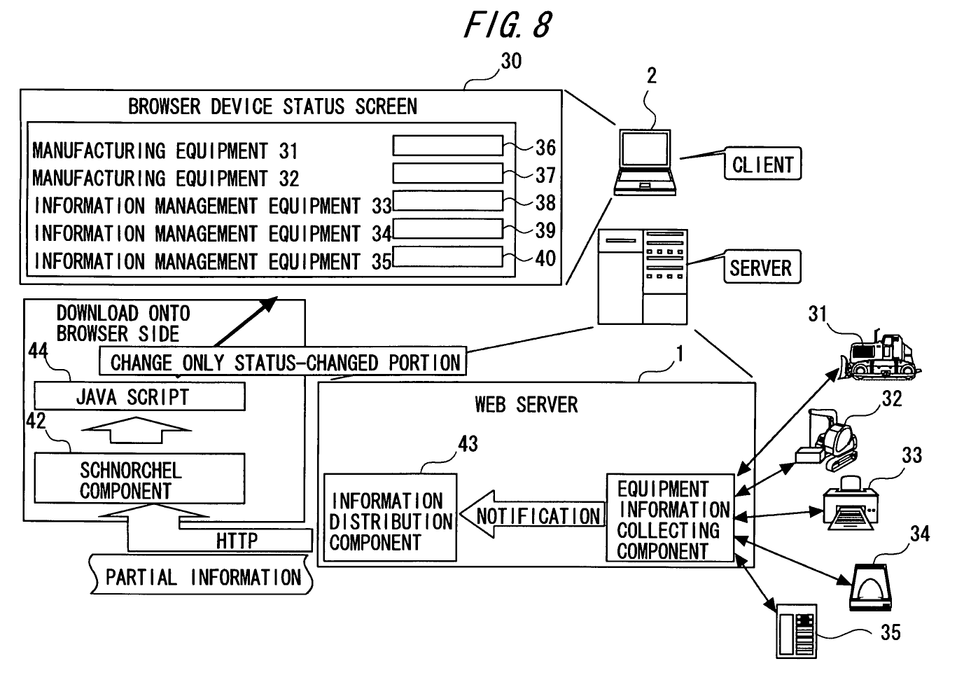

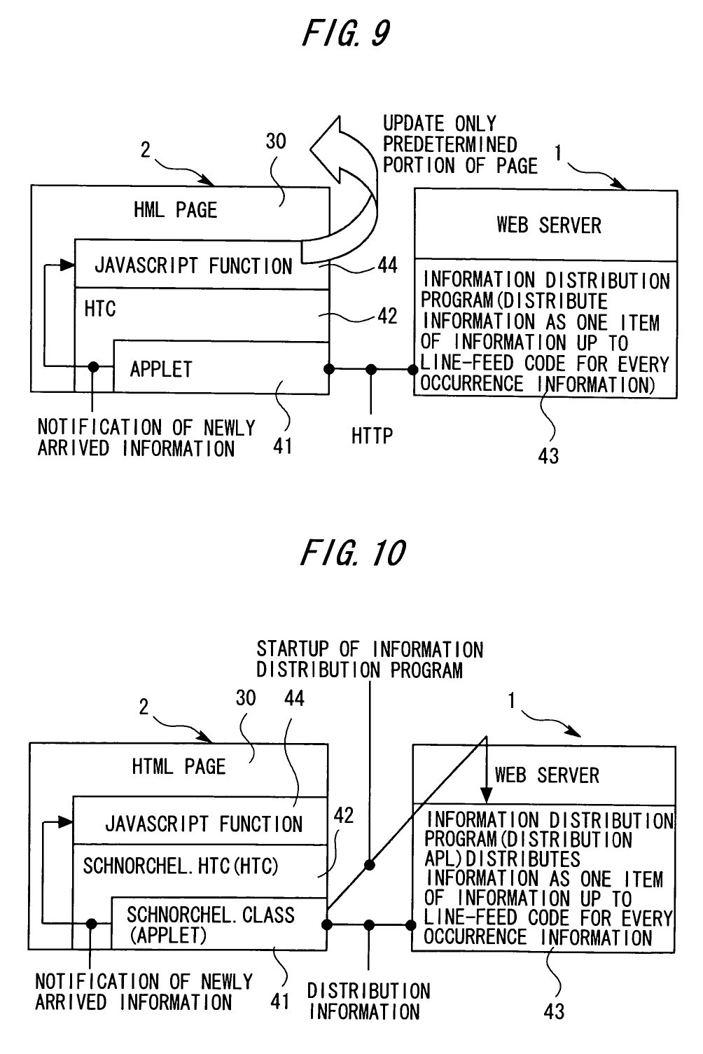

For example, as shown in FIGS. 8 and 9, when equipment names 31-35 and equipment status fields 36-40 are displayed on a management screen 30, if a status of the manufacturing equipment 31 changes, the distribution APL 43 of the Web server 1 transmits this changed information as the partial information to the client terminal 2. Note that this partial information contains a content of the changed information (content information) and information showing which status field the information should be displayed in (which is update position information). For instance, the distribution APL 43 of the Web server 1 sets, as pieces of content information, operating time, an operating efficiency, information showing whether abnormality occurs or not, etc. which are received from the respective equipment, and attaches tags (update position information) showing the equipment names to the content information, thus generating the partial information.

The Applet (waiting module) 41 of the client terminal 2, which has received the partial information, generates the HTC event, and a JavaScript function 44 for reception updates (values in) the status fields 36-40. Herein, the reception JavaScript function 44, as seen in the status field 36 if the equipment name specified by the tag is the manufacturing equipment 31 and in the status field 37 if the equipment name is the manufacturing equipment 32, displays the content information in a portion associated with the tag defined in the HTC description part. This enables only the change-occurred status fields 36-40 to be partially updated, whereby network bands are not consumed with futility.

Then, when the administrator manipulates to finish the asynchronous communications, the connection module of the client terminal 2 and the connection module of the Web server 1 make the asynchronous path (connection) open (S12).

### SPECIFIC EXAMPLES

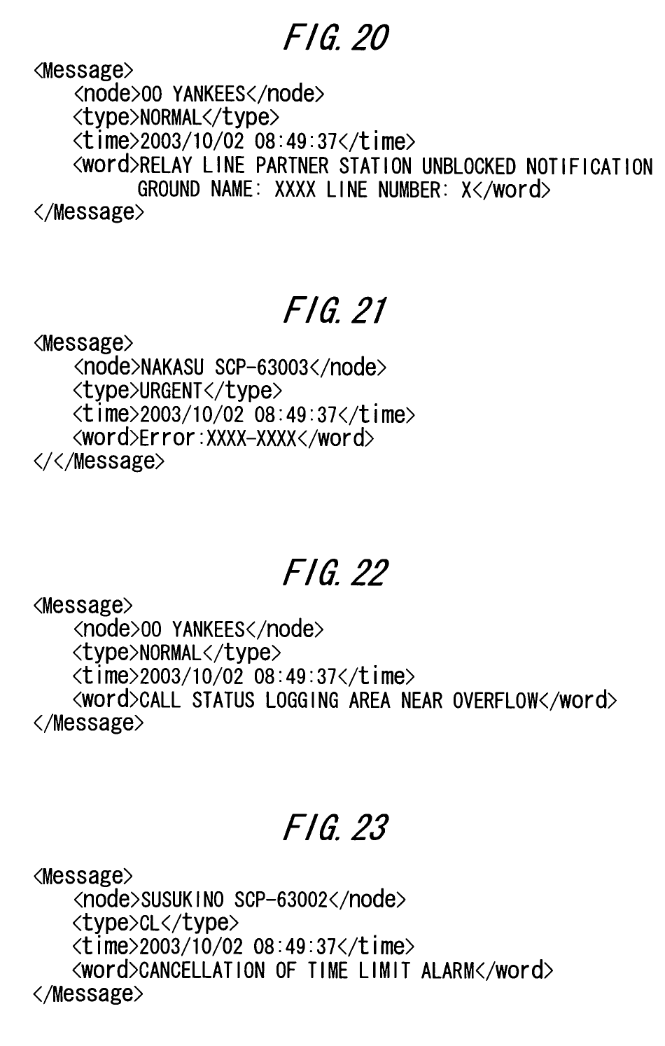

Specific examples of the asynchronous communication system and the asynchronous communication method based on this system according to the invention, will be explained with reference to FIGS. 10 through 27.

As shown in FIG. 10, the communication component of the client terminal 2 is constructed of an Applet 41 having a class name of “Schnorchel” that is specialized exclusively for the HTTP-based communications, and a HTC file 42 having a tag name of “Schnorchel” that is loaded inside with (implements) the Applet 41.

Note that open HTC specifications for incorporating the component are as follows.
[Open Tag Name]: Schnorchel
[Open Method]: lookup (information distribution program 43 URL), the information distribution program running on the Web server is started up by invoking this method, and there is a wait for incoming of the information.
[Open Event]: listener, the reception JavaScript function 44 having, as an argument, an event for receiving the information as the HTML page, is set in this “listener” event.

Namely, the client terminal 2, when developing the communication component, instructs the server 1 to detect the updating of the content and to start distributing the partial information by invoking the “lookup” method, and starts waiting by starting up the “Schnorchel.class” 41. Then, the “Schnorchel.class” 41 stores the partial information in “event.message” each time the partial information arrives, and notifies the reception JavaScript function 44 by the “listener” event that the new information arrives. The JavaScript function 44 inserts the partial information read from the “event.mssage” into a corresponding portion (the status fields 36-40) on the management screen 30 as the HTC (HTML Component).

On the other hand, the Web server 1 has an information distribution program (Sevlet) 43 for distributing the information for this communication component, and transmits the partial information asynchronously. The information distribution program on the side of the Web server is exemplified such as “Sevlet” and, without being limited to “Sevelt”, may be enough if capable of transmitting the partial information in a predetermined format enabling the transmission of the updated portion and the updated content to the Applet 41 on the terminal side, wherein other methods (technologies) such as CGI (Common Gateway Interface), PHP (Hypertext Preprocessor) and ASP (Active Server Pages) may also be employed.

FIGS. 11 through 14 are examples of the management screen 45 for managing statuses of nodes on the network. FIG. 11 illustrates the management screen 45 before receiving the partial information.

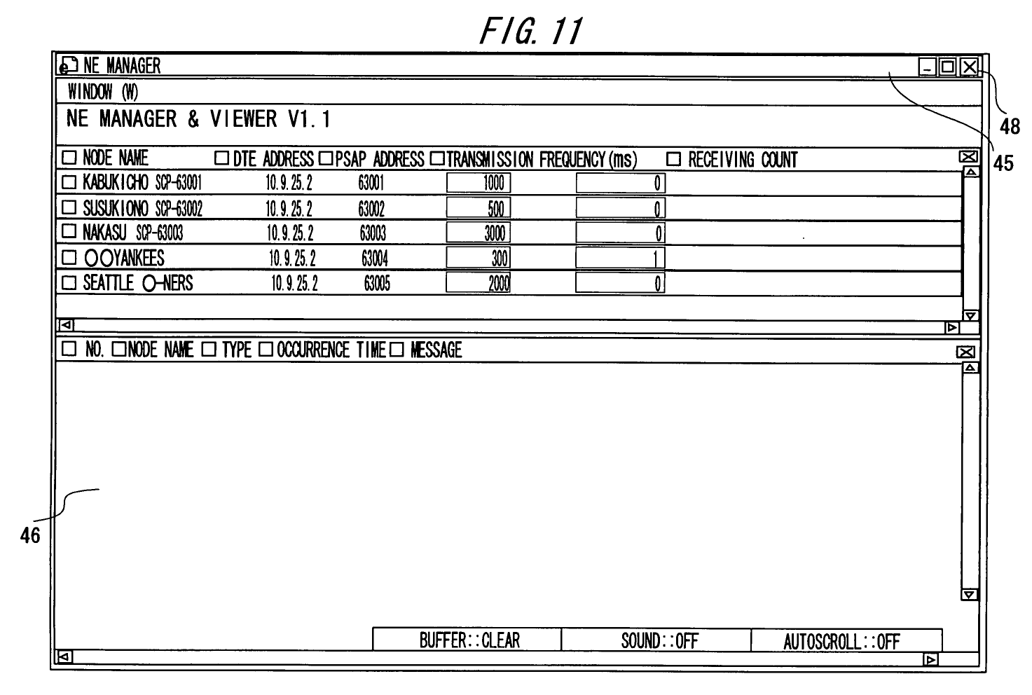

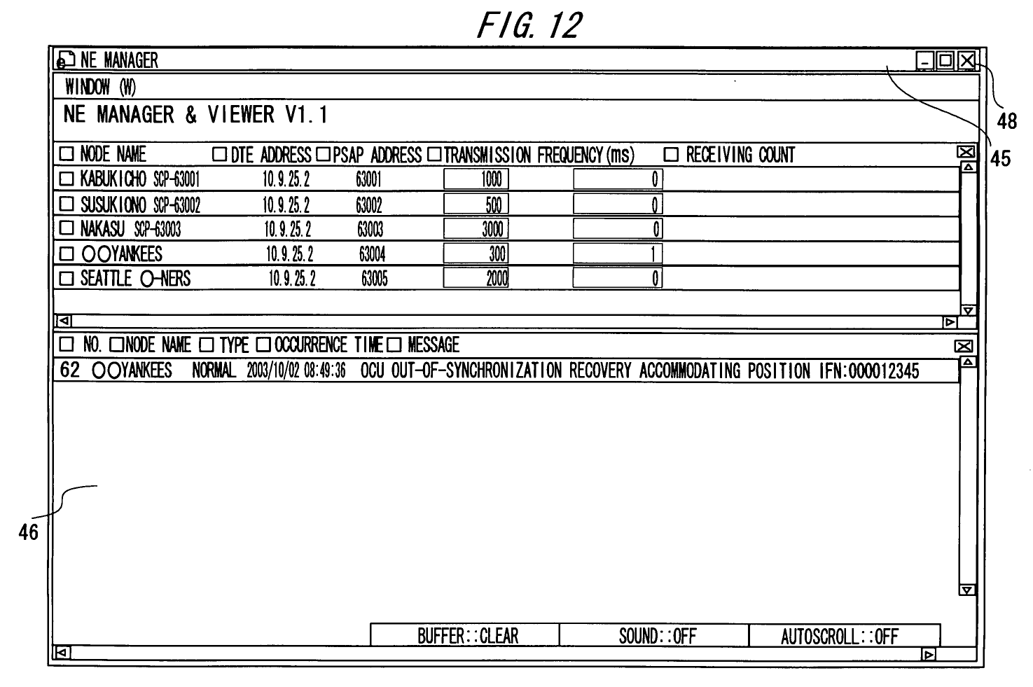

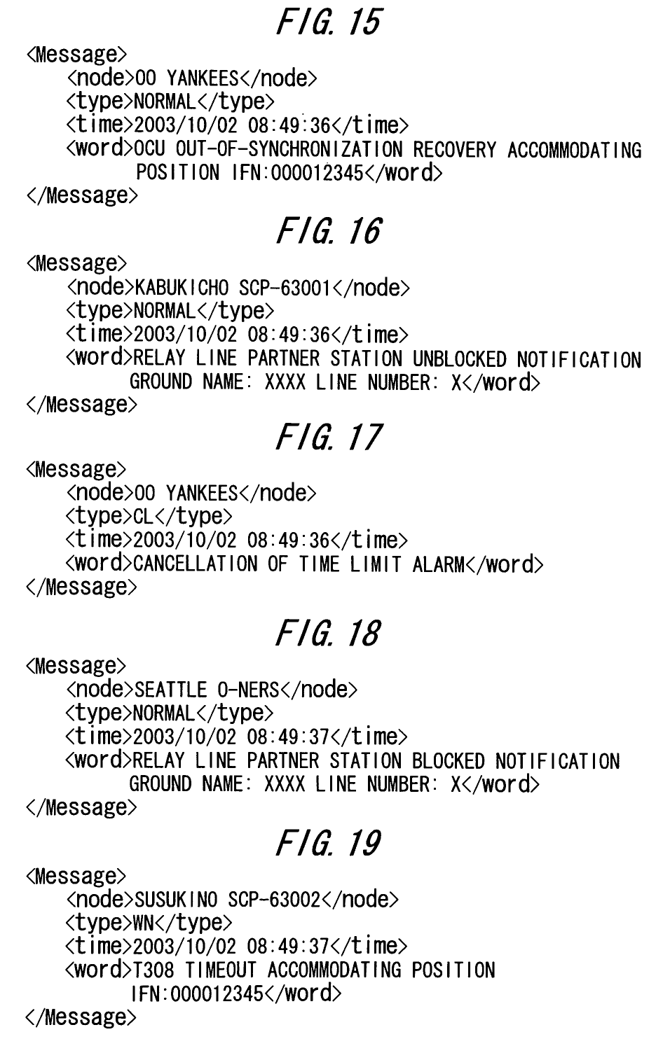

Then, when the Web server 1 detects a change of status of the node (oo Yankees) and transmits the partial information shown in FIG. 15 to the client terminal 2, the client terminal 2 updates display in a status display field 46 based on this partial information as shown in FIG. 12. Herein, in the partial information shown in FIG. 15, a tag set of <Message>, </Message> specifies one-line information displayed in the status display field 46, a tag set of <node>, </node> represents a node name, a tag set of <type>, </type> indicates a type, a tag set of <time>, </time> represents occurrence time, and <word>, </word> are tags (tag set) for specifying information (update position information) that should be displayed in a line of message. Namely, the JavaScript function 44 gets items of information (content information) delimited by these tag sets displayed respectively in HTC-defined lines.

Next, in the case of receiving the partial information shown in FIG. 16, the client terminal 2 gets the items of content information displayed in the respective lines in the status display field 46 in the same way as described above. In the example, a newly-received item of information is displayed in the uppermost line, and the previous items of information are displayed in a way that carries down the previous information on a line-by-line basis.

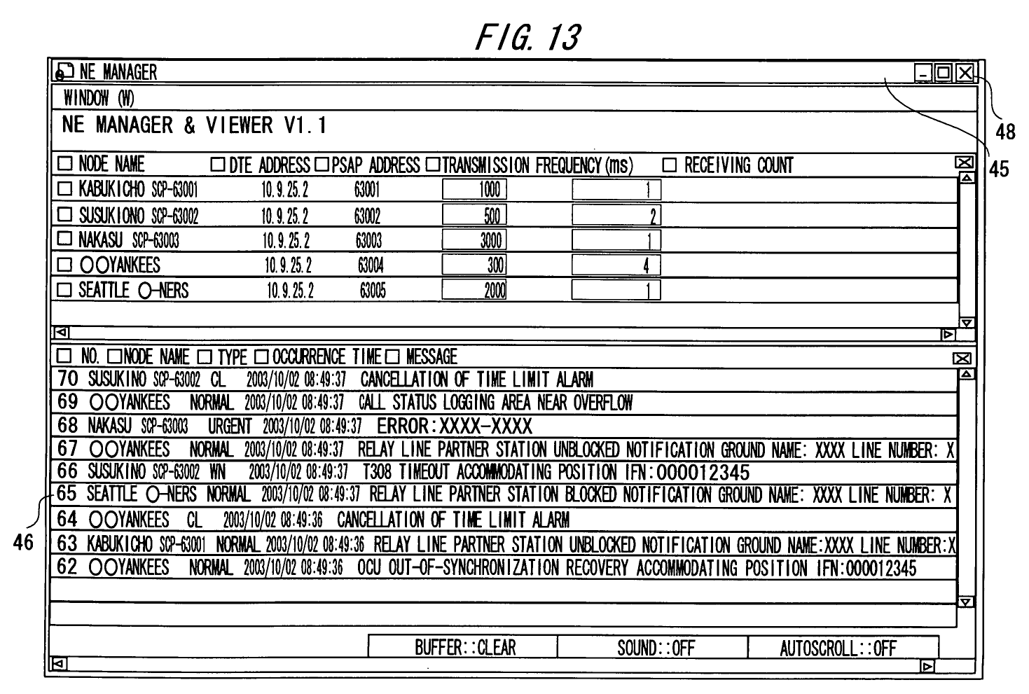

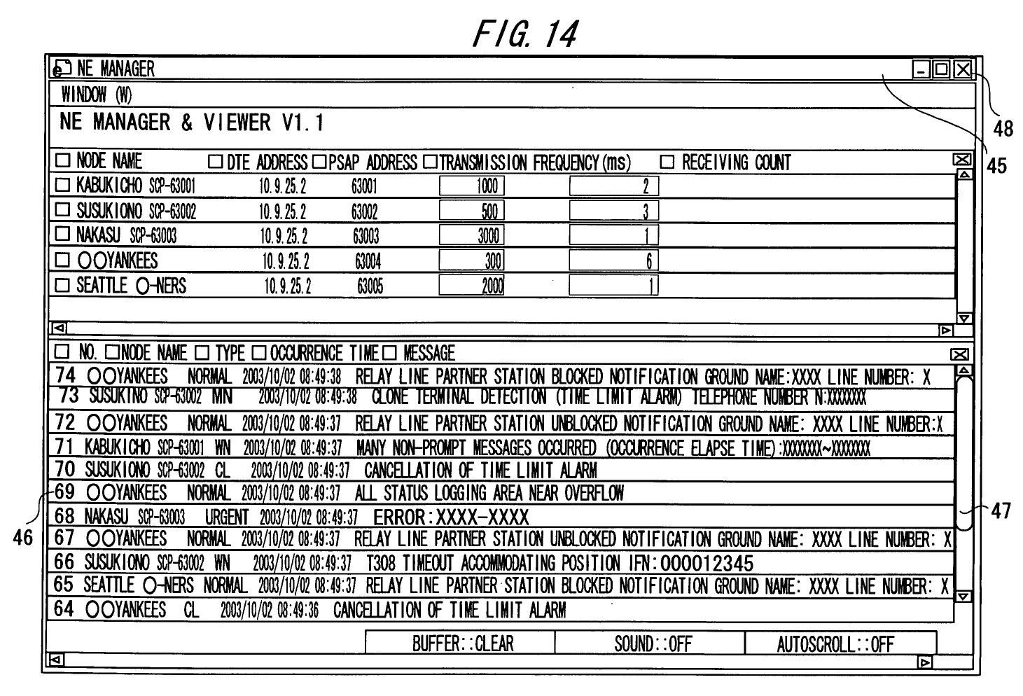

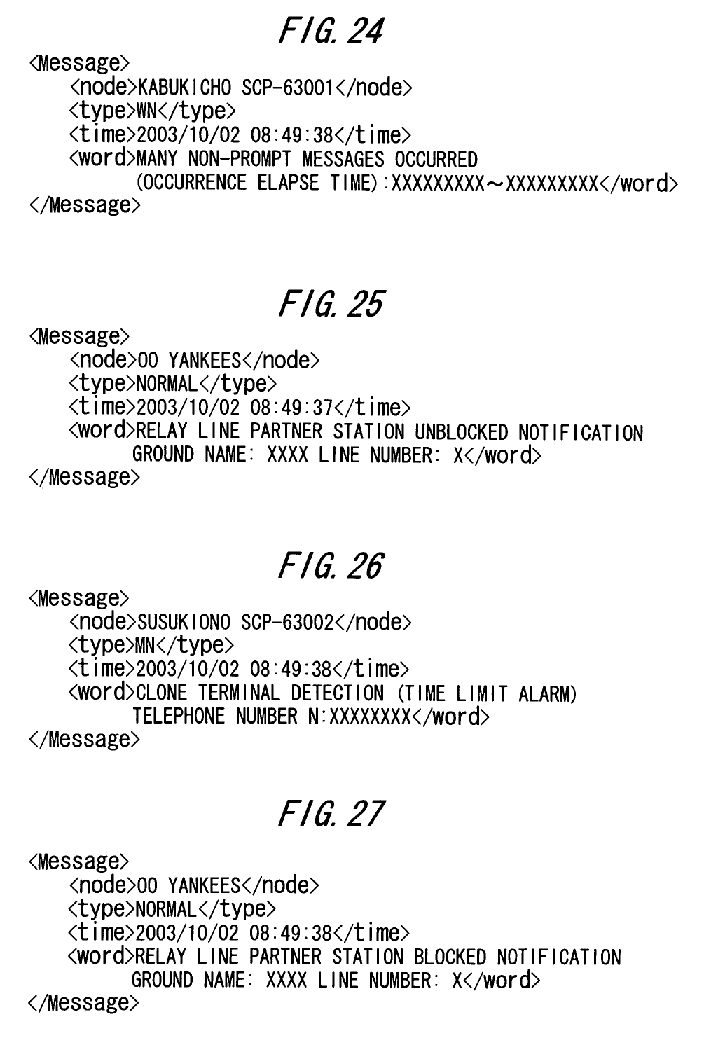

FIG. 13 shows a result of similarly repeating the partial updating by sequentially receiving the items of partial information in FIGS. 17 through 23, and further FIG. 14 shows a result of similarly repeating the partial updating by sequentially receiving the items of partial information in FIGS. 24 through 27.

As shown in FIG. 14, if the number of items of the received partial information exceeds the number of display lines in the status display field 46, the old information corresponding to the excess may be deleted and may also be set scrollable by providing a scroll bar 47.

Then, when the administrator performs a finishing operation such as selecting a close button 48, the connection module of the client terminal 2 and the connection module of the Web server 1 close the browser by disconnecting the asynchronous path.

Thus, according to the embodiment, the status of the equipment is asynchronously transmitted from the server 1 and can be displayed on the client terminal 2. This enables the administrator to manage the status of the equipment in the remote place on the Web browser in real-time via the network such as the Internet.

In the embodiment, the Web server 1 receives the information from the equipment with a period of 300 ms through 3000 ms and can therefore notify the client terminal 2 of the status change at a timing corresponding to this period.

On the other hand, in a conventional polling type system, actualization of the same real-time property must involve giving a query to the Web server from the client terminal at an interval of at least 300 ms, and this scheme is not realistic.

Further, the communication system 10 in the embodiment can rewrite partially the management screen and therefore has no necessity of transmitting the information on the whole screen on an update-by-update basis, thereby making it possible to employ the network bands at a high efficiency.

Note that the partial information is transmitted as the HTTP-based plain text in the embodiment, however, this format may be enough if capable of transmitting the updated content and the updated portion as by the simple text, HTML, XML, etc. without being limited in particular. Further, an image and a program may also be available without being limited to the plain text.

<Others>

The invention is not limited to only the illustrated examples given above and can be, as a matter of course, changed in a variety of forms in the range that does not deviate from the gist of the invention.

For example, even the configurations given in the following Notes can acquire the same effects as those in the embodiment discussed above. Further, the components thereof can be combined to the greatest possible degree.

(Note 1)

An asynchronous communication method performed by a management device and a client terminal that are connected via a network,

the management device executing:

a step of establishing a connection with the client terminal that transmits at least part of a content via the network;

a step of detecting an update of the content; and

a step of transmitting the updated portion to the client terminal as triggered by the detected update of the content,

the client terminal executing:

a step of establishing a connection with the management device;

a step of waiting for the updated portion of the content; and

a step of updating partially the content on the basis of the updated portion received during the waiting step.

(Note 2)

An asynchronous communication method according to Note 1, wherein the content is monitor information of a device, and

the management device acquires the monitor information of the device and, if the monitor information changes, detects this change as an update of the content, and transmits information of the updated portion from the monitor information as an updated portion.

(Note 3)

An asynchronous communication method according to Note 1, wherein the management device further executes a step of transmitting, as the content, an HTML- or XML-described Web page to the client terminal, and

the client terminal further executes a step of receiving the Web page as the content, and updates a portion defined by the description in the Web page on the basis of the updated portion.

(Note 4)

An asynchronous communication method according to Note 1, wherein the client terminal transmits the updated portion in an XML format or a CSV (Comma Separated Value) format.

(Note 5)

An asynchronous communication program executed by a management device connected to a client terminal via a network, the program making the management device execute:

a step of establishing a connection with the client terminal that transmits at least part of a content via the network;

a step of detecting an update of the content; and

a step of transmitting the updated portion to the client terminal as triggered by the detected update of the content.

(Note 6)

An asynchronous communication program according to Note 5, wherein the content is monitor information of a device, and

the monitor information of the device is acquired, if the monitor information changes, this change is detected as an update of the content, and information of the updated portion from the monitor information is transmitted as an updated portion.

(Note 7)

An asynchronous communication program according to Note 5, wherein the updated portion is transmitted in an XML format or a CSV (Comma Separated Value) format.

(Note 8)

A client terminal connected to a management device via a network, comprising:

a connection module establishing a connection with the management device in order to receive at least part of a content via the network;

a waiting module waiting for the updated portion of the content; and

a partial updating module updating partially the content on the basis of the updated portion received by the waiting portion.

(Note 9)

An asynchronous communication method performed by a client terminal connected to a management device via a network, the client terminal executing:

a step of establishing a connection with the management device in order to receive at least part of a content via the network;

a step of waiting for the updated portion of the content; and

a step of updating partially the content on the basis of the updated portion received by the waiting portion.

(Note 10)

An asynchronous communication program executed by a client terminal connected to a management device via a network, the program making the client terminal execute:

a step of establishing a connection with the management device in order to receive at least part of a content via the network;

a step of waiting for the updated portion of the-content; and

a step of updating partially the content on the basis of the updated portion received by the waiting portion.

<Incorporation by Reference>

The disclosures of Japanese patent application No.JP2005-086067 filed on Mar. 24, 2005 including the specification, drawings and abstract are incorporated herein by reference.

What is claimed is:

1. An asynchronous communication system configured by a management device and a client terminal that are connected via a network,
the management device comprising:
a connection module establishing a connection with the client terminal that transmits at least part of a content via the network;
a detection module detecting an update of the content; and
a partial distribution module transmitting the updated portion to the client terminal as triggered by the update of the content that has been detected by the detection module,
the client terminal comprising:
a connection module establishing a connection with the management device;
a waiting module waiting for the updated portion of the content; and
a partial updating module updating partially the content on the basis of the updated portion received by the waiting portion.

2. An asynchronous communication system according to claim 1, wherein the content is monitor information of a device,
the detection module acquires the monitor information of the device and, if the monitor information changes, detects this change as an update of the content, and
the partial distribution module transmits information of the updated portion from the monitor information as an updated portion.

3. An asynchronous communication system according to claim 1, wherein the management device further comprises a content distribution module transmitting, as the content, an HTML- or XML-described Web page to the client terminal, and
the client terminal further comprises a content receiving module receiving the Web page as the content, and the partial updating module updates a portion defined by the description in the Web page on the basis of the updated portion.

4. An asynchronous communication system according to claim 1, wherein the partial distribution module transmits the updated portion in an XML format or a CSV (Comma Separated Value) format.

5. A management device connected to a client terminal via a network, comprising:
a connection module establishing a connection with the client terminal that transmits at least part of a content via the network;
a detection module detecting an update of the content; and
a partial distribution module transmitting the updated portion to the client terminal as triggered by the update of the content that has been detected by the detection module.

6. A management device according to claim 5, wherein the content is monitor information of a device,
the detection module acquires the monitor information of the device and, if the monitor information changes, detects this change as an update of the content, and
the partial distribution module transmits information of the updated portion from the monitor information as an updated portion.

7. A management device according to claim 5, wherein the partial distribution module transmits the updated portion in an XML format or a CSV (Comma Separated Value) format.

8. An asynchronous communication method performed by a management device connected to a client terminal via a network,
the management device executing:
a step of establishing a connection with the client terminal that transmits at least part of a content via the network;
a step of detecting an update of the content; and
a step of transmitting the updated portion to the client terminal as triggered by the detected update of the content.

9. An asynchronous communication method according to claim 8, wherein the content is monitor information of a device, and
the monitor information of the device is acquired, if the monitor information changes, this change is detected as an update of the content, and information of the updated portion from the monitor information is transmitted as an updated portion.

10. An asynchronous communication method according to claim 8, wherein the updated portion is transmitted in an XML format or a CSV (Comma Separated Value) format.
